(19) United States
(12) Patent Application Publication
(10) Pub. No.: US 2004/0117930 A1
(43) Pub. Date: Jun. 24, 2004

(54) Toothbrush

(75) Inventors: Patrick J. Townley, White Bear Township, MN (US); Paul E. Hansen, Lake Elmo, MN (US); David E. Johnson, Maplewood, MN (US); Steven J. Maxa, Burnsville, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/325,510

(22) Filed: Dec. 19, 2002

(51) Int. Cl. A61C 17/26; A46B 9/04

(52) U.S. Cl. 15/28; 15/22.1; 15/167.1

(57) ABSTRACT

A toothbrush including bristles dispersed uniformly over a base surface is disclosed. In various combinations, the bristles may be individually oriented at an included angle of less than 90 degrees with a longitudinal axis of the toothbrush, substantially all of the bristles may individually be in contact with at least one other bristle, the bristles may define an arcuate cylindrical bristle surface, and/or the bristles may be dispersed randomly within a single group.

### FIELD OF INVENTION

The present invention relates generally to the field of oral care, and in particular to a toothbrush.

### BACKGROUND

Conventional toothbrushes are typically manufactured by attaching groups of bristles (“tufts”) to the plastic head of the toothbrush. The tufts can be adhered in many ways. In one well-known method, each tuft is formed from a plurality of individual bristles folded into a U-shaped configuration. The folded tufts are then inserted into apertures, or cavities, provided in the head of the toothbrush. Each tuft is made up of anywhere from 2-60 individual bristles, depending on the manufacturer's design and toothbrush type. For example, a “soft” bristled toothbrush may have different length and diameter bristles than a “medium” bristled toothbrush.

In another method of manufacture, each tuft also includes a plurality of individual bristles. A number of bristle tufts, each of the tufts including a plurality of individual bristles, are inserted into respective holes in a first mold member such that a length of the tuft protrudes from a side of the mold member that will subsequently form an inner surface of the mold cavity for the brush body. At least a portion of the protruding length of each tuft is then fused into a mass having a larger cross-section than that of the holes at the inner side of the first mold member. The first mold member is then mated with a second mold member to define the mold cavity for the brush body and molding material is injected into the cavity to form the final brush product.

In other toothbrushes, one or more groups of bristles may be attached as hanks. Each hank includes a plurality of bristles that are held in place, at least partially, by friction.

One potential problem associated with toothbrushes manufactured with tufts or hanks is that bristles incorporated into the tufts or hanks are not free to bend and flex independently because each bristle's movement is constrained at least partially by the surrounding bristles. Thus, the bristles may not be able to independently follow the irregular contours along the tooth's structure.

Another potential disadvantage of many toothbrushes is that the ends of the bristles, whether in hanks or tufts, define a generally flat “bristle surface,” i.e., a surface in which the ends of the bristles are located (with a flat bristle surface generally defining a plane). In such a flat bristle surface, the ends of the tufts or hanks can prevent nearby bristles from penetrating into grooves in the teeth. In addition, the interproximal access of the bristle may be limited by the bulky diameter of the densely packed bristle tufts or hanks.

### SUMMARY OF THE INVENTION

The present invention provides a toothbrush that includes individual bristles that are dispersed uniformly over a base surface of the toothbrush. The uniformly spaced individual bristles may allow better interproximal access than the tufts or hanks of bristles used in toothbrushes known in the art.

It may be preferred that the uniformly dispersed bristles are randomly dispersed over the base surface of the bristle pad. The uniformly and, optionally, randomly dispersed bristles may be arranged with minimum bristle density of 5 bristles/mm² or more and/or an upper bristle density of 25 bristles/mm² or less (both based on an average of bristle density measured over the area occupied by the bristles).

In some embodiments of the present invention, the toothbrush includes bristles that are individually oriented at an included angle of less than 90 degrees with the longitudinal axis as measured in a plane defined by the longitudinal axis and the bristle.

Another optional feature of toothbrushes according to the present invention is that substantially all of the individual bristles may individually be in contact with at least one other bristle somewhere along the exposed length of bristle above the base surface.

In some embodiments of the present invention, the toothbrush includes individual bristles that form an arcuate cylindrical bristle surface. The arcuate cylindrical bristle surface and the individual bristles may allow the bristles to penetrate into grooves without interference from adjacent bristles. In such a toothbrush or other embodiments of the present invention, it may be preferred that the bristles are aligned generally radially with respect to the longitudinal axis.

In addition, the toothbrush, in some embodiments, may include a bristle pad that is removably attached to a bristle pad base, thereby allowing a user to select various bristle pads having different characteristics, e.g., stiffness, bristle length, density, etc.

Among the advantages provided by the present invention is the ability to clean interdental portions, cervical portions, pits, and fissures more effectively.

In one aspect, the present invention provides a toothbrush having a proximal end and a distal end; a longitudinal axis extending from the proximal end to the distal end; and a bristle pad proximate the distal end of the toothbrush, the bristle pad including a plurality of bristles embedded in a base surface, wherein the plurality of bristles are dispersed uniformly over the base surface, wherein the plurality of bristles define an arcuate cylindrical bristle surface spaced from the base surface, and wherein substantially all of the bristles on the bristle pad are individually oriented at an included angle of less than 90 degrees with the longitudinal axis as measured in a plane defined by the longitudinal axis and the bristle.

In another aspect, the present invention provides a toothbrush having a proximal end and a distal end; a longitudinal axis extending from the proximal end to the distal end; and a bristle pad proximate the distal end of the toothbrush, the bristle pad including a plurality of bristles embedded in a base surface, wherein the plurality of bristles are dispersed uniformly over the base surface, wherein substantially all of the bristles of the plurality of bristles are individually in contact with at least one other bristle, and wherein substantially all of the bristles on the bristle pad are individually oriented at an included angle of less than 90 degrees with the longitudinal axis as measured in a plane defined by the longitudinal axis and the bristle.

In another aspect, the present invention provides a toothbrush having a proximal end and a distal end; a longitudinal axis extending from the proximal end to the distal end; and a bristle pad proximate the distal end of the toothbrush, the bristle pad including a plurality of bristles embedded in a base surface, wherein all of the bristles on the bristle pad are arranged in only a single group on the bristle pad, with the bristles in the single group dispersed uniformly within the single group, and wherein each bristle of the plurality of bristles is aligned generally radially with respect to the longitudinal axis, and wherein the base surface occupies an arc of 180 degrees or less with respect to the longitudinal axis.

In another aspect, the present invention provides a motorized toothbrush having a proximal end and a distal end defining a longitudinal axis extending from the proximal end to the distal end; a housing including a motor and a shaft; and a bristle pad operably connected to the shaft for movement relative to the longitudinal axis. The bristle pad includes a plurality of bristles embedded in a base surface, wherein the plurality of bristles are dispersed uniformly over the base surface, and wherein substantially all of the bristles of the plurality of bristles are individually in contact with at least one other bristle.

These and other features and advantages of toothbrushes according to the present invention may be discussed below with respect to various illustrative embodiments of the invention as defined by the claims.

### BRIEF DESCRIPTION OF THE DRAWINGS

FIG. 1 is a perspective view of one toothbrush according to the present invention.

FIG. 2 is a cross-section view of the toothbrush of FIG. 1 taken along line 2-2.

FIG. 3 is a cross-section view of the toothbrush of FIG. 1 taken along line 3-3.

FIG. 4 is a perspective view of a motorized toothbrush according to one embodiment of the present invention.

FIG. 5 is a schematic diagram of a toothbrush kit according to another embodiment of the present invention.

### DETAILED DESCRIPTION OF ILLUSTRATIVE EMBODIMENTS OF THE INVENTION

In the following detailed description of illustrative embodiments, reference is made to the accompanying drawings that form a part hereof, and in which are shown, by way of illustration, specific embodiments in which the invention may be practiced. It is to be understood that other embodiments may be utilized and structural changes may be made without departing from the scope of the present invention.

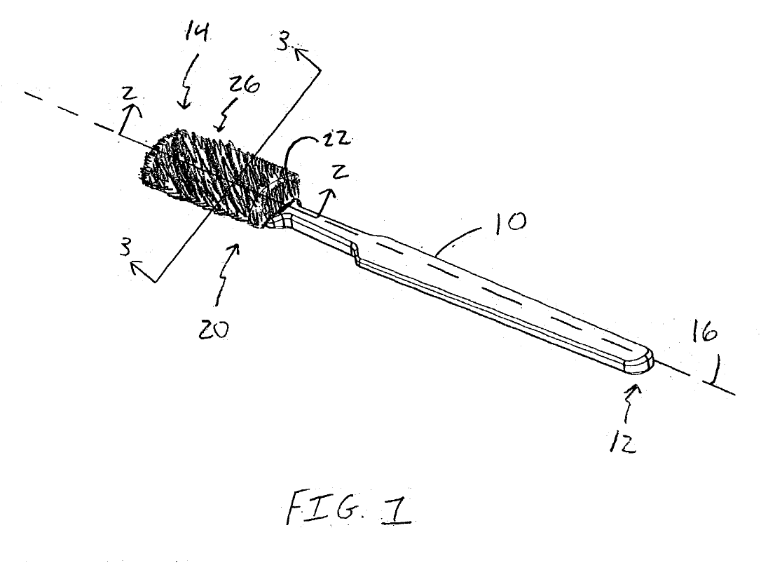

FIGS. 1-3 depict one illustrative embodiment of a toothbrush according to the present invention. The toothbrush includes a handle 10 with a proximal end 12 and a distal end 14 opposite the proximal end 12. A longitudinal axis 16 extends from the proximal end 12 to the distal end 14.

The toothbrush may be made of any suitable material known in the art, e.g., polymeric materials, metal, wood, fiberglass, etc., and combinations thereof. The toothbrush handle 10 may be any suitable shape, e.g., rectangular, cylindrical, etc. It may be preferred that toothbrush handle 10 is shaped such that it conforms with the hand of a user.

Further, the toothbrush handle 10 may include a flexible member proximate the distal end 14 as described in U.S. Pat. No. 6,003,189 to Falleiros et al. entitled “Toothbrush.” The flexible member may flex if a user applies excessive force to the distal end 14 of the toothbrush handle 10 while brushing.

The toothbrush includes a bristle pad 20 proximate the distal end 14 of the toothbrush handle 10. The bristle pad 20 includes a plurality of bristles 26 and may be attached proximate the distal end 14 using any suitable technique known in the art, e.g., adhesives, mechanical fasteners, welding (thermal or chemical), etc. In one embodiment, the bristle pad 20 may be removably attached to the handle 10 as is further described herein. Although the bristle pad 20 may be provided as a separate unit attached to the handle 10, the bristles 26 may alternatively be embedded directly into the handle 10, in which case the bristle pad 20 is integral with the handle 10.

The bristle pad 20 may take any suitable shape, e.g., rectangle, oval, circle, parallelogram, etc. It may be preferred that bristle pad 20 take a generally rectangular shape as illustrated, e.g., in FIG. 1. Further, the bristle pad 20 may be manufactured using any suitable material, e.g., polymeric materials, metal, wood, fiberglass, etc., and combinations thereof.

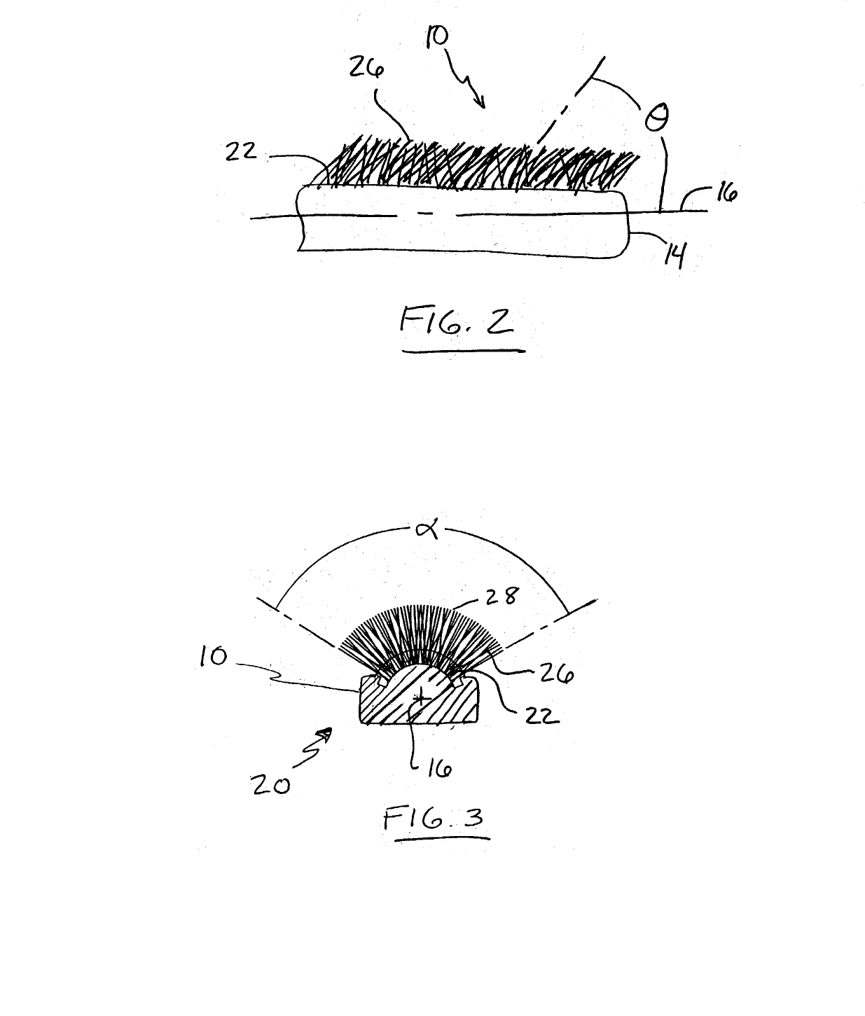

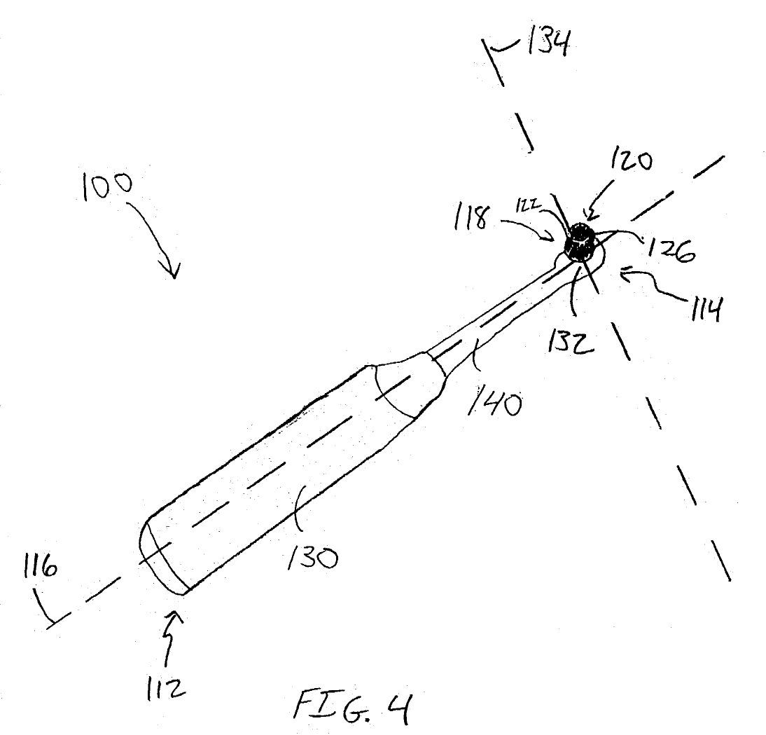

The bristle pad 20 includes a base surface 22 that, in the depicted embodiment, forms an arcuate cylindrical segment (see, e.g., FIG. 3). Although the arcuate cylindrical segment of the depicted base surface 22 is defined by an axis that would generally align with the longitudinal axis 16 of the handle 10, such an arrangement may not be required.

The base surface 22 may be formed into an arcuate cylindrical segment using several different techniques. For example, the distal end 14 of toothbrush handle 10 may include an arcuate cylindrical segment such that the attached bristle pad 20 conforms to the surface of distal end 14. Alternatively, the bristle pad 20 itself may be formed in an arcuate cylindrical segment prior to being attached to the distal end 14. In another alternative embodiment, the bristle pad 20 may be of a width transverse to longitudinal axis 16 that is greater than a width of the distal end 14. The distal end 14 in turn may include grooves or notches configured such that the bristle pad 20 will engage the notches and slide into place along the longitudinal axis 16 such that the bristle pad 20 takes on an arcuate cylindrical segment due to the differences in the width of the bristle pad 20 and the width of the distal end 14 of toothbrush. This configuration may form a gap between the bristle pad 20 and the distal end 14 such that the bristle pad 20 may slightly flex when the toothbrush is in use.

The bristle pad 20 of the toothbrush includes bristles 26 that protrude from the base surface 22. The bristles 26 are not bunched together into tufts or hanks, but are, instead, dispersed uniformly over the base surface 22. As used herein, the term “dispersed uniformly over the base surface” is defined as a distribution of bristles over substantially the entire base surface such that individual bristles are not formed in a plurality of tufts, hanks, or bundles.

It may be further preferred that the bristles 26 be dispersed randomly over the base surface 22, i.e., that the bristles not be arranged in a specific pattern on the base surface 22.

In some embodiments of toothbrushes according to the present invention, substantially all of the bristles 26 may individually be oriented at an included angle θ (theta) of less than 90 degrees with the longitudinal axis as measured in a plane defined by the longitudinal axis 16 and an individual bristle 26 (see, e.g., FIG. 2). It may be preferred that substantially all of the bristles 26 are oriented at an included angle of 80 degrees or less. It may be more preferred that substantially all of the bristles 26 are individually oriented at an included angle of 70 degrees or less. The bristles 26 may be oriented such that the included angle θ (theta) is located facing toward or away from the distal end 14 of handle 10.

In various embodiments, substantially all of the bristles 26 may be oriented in the same direction (towards the distal end 14 or away from the distal end 14) or some bristles 26 may be oriented in one direction while other bristles 26 are oriented in the opposite direction. Even in those embodiments in which substantially all of the bristles 26 are oriented in the same direction, some of the bristles 26 may be oriented in the opposite direction or may be oriented normal to the base surface 22. Such an arrangement is depicted in FIG. 2 in which the vast majority of bristles 26 are oriented towards the distal end 14, but some of the bristles 26 are oriented normal to the base surface 22 and others are oriented in the opposite direction (away from the distal end 14).

Another manner in which the present invention may be characterized is that it may be preferred that substantially all of the bristles 26 are individually in contact with at least one other bristle at one or more locations along the length of the bristle. Although substantially all of bristles 26 may individually be in contact with at least one other bristle, substantially all of bristles 26 may also individually form an included angle θ (theta) with the longitudinal axis as described herein.

The present invention may also be characterized in terms of bristle density at the base surface 22 from which the bristles protrude. For example, the bristles 26 may be arranged on the base surface 22 with a minimum bristle density of 5 bristles/mm² or more. At the upper end of the bristle density range, it may be preferred that the bristles 26 be arranged with a maximum bristle density of 25 bristles/mm² or less. Bristle density as used herein is the average bristle density over the area occupied by the bristles.

If the bristles 26 are arranged such that each bristle 26 is individually aligned generally radially with respect to the longitudinal axis of the handle 10 (see, e.g., FIG. 3), the bristle density decreases as the distance from the base surface 22 increases. That decreasing bristle density may be advantageous because each bristle 26 may have more freedom or range of motion to, e.g., penetrate fissures, spaces between teeth, etc. In combination with that freedom of movement proximate the free ends of the bristles 26, each of the bristles 26 may still be supported by adjacent bristles 26 proximate the base surface 22, thereby providing sufficient stiffness to the individual bristles.

Another manner in which toothbrushes of the present invention may be characterized is in terms of the number of groups in which the bristles are arranged on the bristle pad 20. For example, it may be preferred that the bristles 26 are arranged in only a single group on the bristle pad 20, with the bristles 26 dispersed uniformly within the single group. It may further be preferred that the bristles 26 are dispersed randomly within the single group.

Each bristle of bristles 26 may be manufactured using any suitable material, e.g., polymeric materials, nylons, etc. The bristles 26 may include additional materials that are either mixed throughout the bristle or that coat the outer surfaces of the bristle, e.g., abrasives, antimicrobial agents, whitening agents, coatings to improve flocking, etc.

Each bristle 26 may be any suitable shape, e.g., cylindrical, conical, rectilinear, etc. Each bristle 26 may further include a tapered end distal from the base surface. In an alternative embodiment, the ends of bristles 26 may be rounded.

The bristles 26 may each be of the same length. In other words, all of the bristles 26 may terminate at substantially the same distance from the base surface 22. For example, each bristle 26 may include a length from the base surface to a distal end of the bristle of 15 mm or less, more preferably 10 mm or less. It may be preferred that each bristle 26 has a length of 4 mm to 6 mm.

Bristle diameter may vary as desired based on a variety of factors such as the materials used for the bristles, the length of the bristles, etc. A suitable range for bristle diameter may be, for example, from 0.05 mm to 0.25 mm, although bristles with diameters outside of that range may also be used in connection with toothbrushes according to the present invention. In other alternatives, toothbrushes according to the invention may include bristles of two or more different diameters arranged in selected patterns according to diameter or randomly interspersed over the bristle pad.

In the embodiment depicted in FIGS. 1-3, bristles 26 define an arcuate cylindrical bristle surface 28 spaced from the base surface 22. Although depicted as an arcuate cylindrical bristle surface 28 in the embodiment of FIGS. 1-3, the bristles may, in other embodiments, define any suitably-shaped bristle surface. For example, in some toothbrushes the bristle surface may be flat (i.e., substantially planar); in other toothbrushes, the bristle surface may be domed (i.e., have curvature about two or more axes). Many other non-planar bristle surface shapes may also be envisioned.

The arcuate bristle surface 28 may be of any suitable arc as measured in a plane perpendicular to the longitudinal axis 16. For example, FIG. 3 illustrates that the arcuate bristle surface 28 may be defined by angle α (alpha). It may be preferred that the center defined by the arcuate bristle surface 28 be coincident with the longitudinal axis 16 as seen in FIG. 3, although the center defined by the arcuate bristle surface 28 may alternatively be displaced from the longitudinal axis 16 of the toothbrush 10. The angle α (alpha) may preferably be 180 degrees or less.

The arcuate bristle surface 28 may facilitate implementation of the Bass brushing technique as described, e.g., in U.S. Pat. No. 5,749,381 to Butler et al. entitled “Toothbrush for Implanting the Bass Brushing Technique.”

Each bristle of bristles 26 may be fastened to the bristle pad 20 using any suitable technique known in the art, e.g., welding on or in the bristle pad 20, injection molding, punch-through attachment, flocking, etc. For example, bristles 26 may be fastened to bristle pad 20 using flocking techniques such as those described, e.g., in U.S. Pat. No. 6,286,246 B1 to Rachal et al. and U. Maag, “Principles of Flocking,” Adhesives Age, pp. 23-28, Vol. 19, No. 9 (Sept. 1975). One alternative technique used to manufacture prototypes during development of the present invention involved flocking bristles onto a vibrating adhesive surface. The adhesive surface and the bristles attached thereto as a result of the flocking was then inverted, with the free ends of the bristles embedded in a curable material which, after curing, retained the bristles after their separation from the adhesive surface. A tilt or angle to the bristles as discussed herein was provided by passing a bar over the free ends of the bristles before embedding the fibers in the curable material. The cured material (with embedded bristles) was then trimmed to provide bristle pads for toothbrushes of the present invention.

The bristle pad 20 may, in some embodiments, be removably attached to the distal end 14 of toothbrush such that a user may remove the bristle pad 20 and replace it with another bristle pad. The toothbrush may be configured to allow for this interchangeability of the bristle pad 20 by any suitable technique known in the art. For example, the distal end 14 of toothbrush handle 10 may include a pair of channels configured to receive the edges of the bristle pad 20 as the bristle pad 20 slides into the channels. The bristle pad 20 may then be secured to the toothbrush by an endcap that is attached to the distal end 14 of the toothbrush.

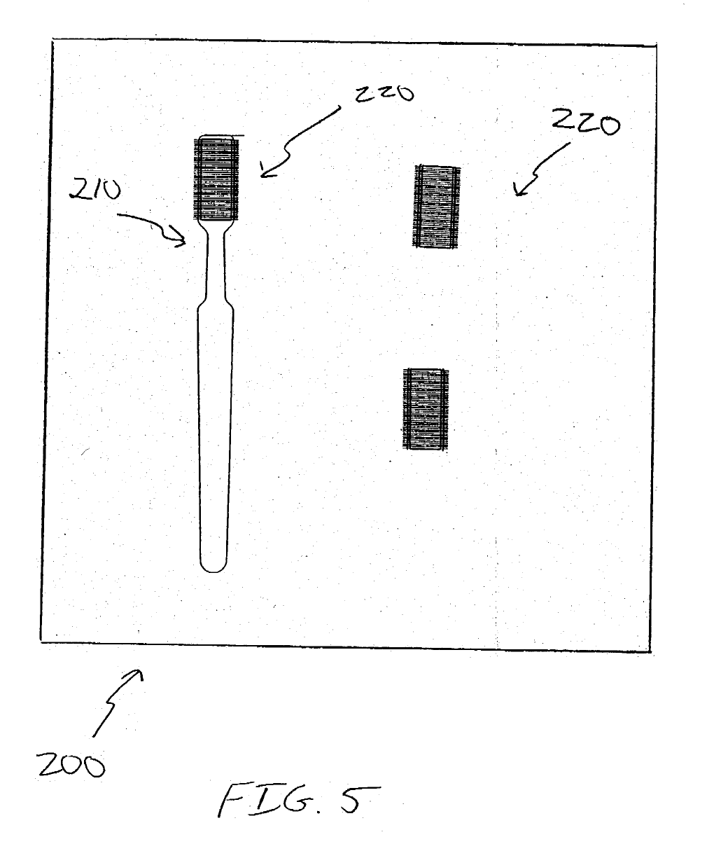

FIG. 4 is a perspective view of a motorized toothbrush 100 according to one embodiment of the present invention. The motorized toothbrush 100 includes a proximal end 112 and a distal end 114. A longitudinal axis 116 extends from the proximal end 112 through the distal end 114. The toothbrush 100 may include a motor and power source located within the toothbrush body 130 as is known in the art.

The toothbrush 100 also includes a shaft 140 attached to the toothbrush body 130. The shaft 140 may be integral with the toothbrush body 130. Alternatively, the shaft 140 may be detachable from the toothbrush body 130 such that the user may select from various shafts or replace shafts that have become worn. For example, the toothbrush 100 may be a part of a kit that includes two or more shafts 140, where each shaft 140 includes bristles having varying stiffness, length, color, etc. as is further described herein. Further, for example, one shaft 140 may have bristles exhibiting a medium average stiffness, while another shaft 140 may have bristles with a soft average stiffness.

Further, the shaft 140 may be configured for attachment to various types of motorized toothbrushes known in the art. The shaft 140 may be manufactured of any suitable material or materials, e.g., polymeric, rubber, metal, etc., and combinations thereof.

The shaft 140 includes a bristle pad base 118 proximate the distal end 114 of toothbrush 100. A bristle pad 120 is attached to the bristle pad base 118 using any suitable technique known in the art. The bristle pad base 118 is configured to provide a surface for the bristle pad 120 to be securely attached to shaft 140. Alternatively, the bristle pad 120 and bristle pad base 118 may be combined into a single integral unit.

The bristle pad 120 may take any suitable shape, e.g., rectangle, oval, etc. Further, the bristle pad 120 may be made of the same or similar materials as those used to manufacture bristle pad 20 described herein in reference to FIGS. 1-3.

The toothbrush 100 is configured such that when activated, the bristle pad base 118 rotates about an axis 134 that is generally perpendicular to the longitudinal axis 116. Alternatively, the toothbrush 100 may be configured such that the bristle pad base 118 moves in an oscillatory, orbital, pulsating, vibratory manner with respect to the body 130.

The bristle pad 120 includes bristles 126 embedded in a base surface 122 of the bristle pad 120. The bristles 126 are similar in many respects to the bristles 26 described herein in reference to the toothbrush of FIGS. 1-3. For example, in one embodiment, the bristles may preferably be dispersed uniformly over the base surface with substantially all of the bristles individually in contact with at least one other bristle at one or more locations along the length of the bristle

In other embodiments, substantially all of bristles 126 may be individually oriented at an included angle of less than 90 degrees with a plane defined by the base surface in which the bristle is embedded.

FIG. 5 is a schematic diagram of a toothbrush kit 200 according to one embodiment of the present invention. The kit 200 includes a toothbrush 210, which may be any toothbrush described herein, e.g., the toothbrush of FIGS. 1-3, and/or the motorized toothbrush of FIG. 4. Also included in the kit 200 are two or more bristle pads 220. For a toothbrush 210, the bristle pads 220 may be attached to the toothbrush 210 at the distal end as described herein. For a motorized toothbrush 210 (e.g., motorized toothbrush 100), the two or more bristle pads 220 may be attached to shafts (e.g., shafts 140) as described herein. The kit 200 allows a user to select a bristle pad from the two or more bristle pads 220 having different characteristics, e.g., bristle stiffness, bristle density, or any other characteristic described herein. The kit 200 may also include one or more containers of toothpaste, floss, or other useful dental materials as is known in the art.

All references and publications cited herein are expressly incorporated herein by reference in their entirety into this disclosure. Illustrative embodiments of this invention are discussed and reference has been made to possible variations within the scope of this invention. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below.

1. A toothbrush comprising:
a proximal end and a distal end;
a longitudinal axis extending from the proximal end to the distal end; and
a bristle pad proximate the distal end of the toothbrush, the bristle pad comprising a plurality of bristles embedded in a base surface, wherein the plurality of bristles are dispersed uniformly over the base surface, wherein the plurality of bristles define an arcuate cylindrical bristle surface spaced from the base surface, and wherein substantially all of the bristles on the bristle pad are individually oriented at an included angle of less than 90 degrees with the longitudinal axis as measured in a plane defined by the longitudinal axis and the bristle.

2. The toothbrush of claim 1, wherein the plurality of bristles are dispersed randomly over the base surface.

3. The toothbrush of claim 1, wherein the plurality of bristles are arranged in only a single group on the bristle pad, with the plurality of bristles dispersed uniformly within the single group.

4. The toothbrush of claim 3, wherein the plurality of bristles are dispersed randomly within the single group.

5. The toothbrush of claim 1, wherein substantially all of the bristles on the bristle pad are oriented in the same direction.

6. The toothbrush of claim 1, wherein the base surface is in the form of an arcuate cylindrical segment.

7. The toothbrush of claim 1, wherein each bristle of the plurality of bristles is individually aligned generally radially with respect to the longitudinal axis.

8. The toothbrush of claim 1, wherein the plurality of bristles are arranged with a bristle density of 5 bristles/mm² or more proximate the base surface.

9. The toothbrush of claim 1, wherein the plurality of bristles are arranged with a bristle density of 25 bristles/mm² or less proximate the base surface.

10. The toothbrush of claim 1, wherein substantially all of the bristles of the plurality of bristles are individually in contact with at least one other bristle.

11. The toothbrush of claim 1, wherein the bristle pad is removably attached to the distal end of the toothbrush.

12. A toothbrush comprising:
a proximal end and a distal end;
a longitudinal axis extending from the proximal end to the distal end; and
a bristle pad proximate the distal end of the toothbrush, the bristle pad comprising a plurality of bristles embedded in a base surface, wherein the plurality of bristles are dispersed uniformly over the base surface, wherein substantially all of the bristles of the plurality of bristles are individually in contact with at least one other bristle, and wherein substantially all of the bristles on the bristle pad are individually oriented at an included angle of less than 90 degrees with the longitudinal axis as measured in a plane defined by the longitudinal axis and the bristle.

13. The toothbrush of claim 12, wherein the plurality of bristles are arranged with a bristle density of 5 bristles/mm² or more proximate the base surface.

14. The toothbrush of claim 12, wherein the plurality of bristles are arranged with a bristle density of 25 bristles/mm² or less proximate the base surface.

15. The toothbrush of claim 12, wherein the plurality of bristles are dispersed randomly over the base surface.

16. The toothbrush of claim 12, wherein the plurality of bristles are arranged in only a single group on the bristle pad, with the plurality of bristles dispersed uniformly within the single group.

17. The toothbrush of claim 16, wherein the plurality of bristles are dispersed randomly within the single group.

18. The toothbrush of claim 12, wherein substantially all of the bristles on the bristle pad are oriented in the same direction.

19. The toothbrush of claim 12, wherein the base surface is in the form of an arcuate cylindrical segment.

20. The toothbrush of claim 12, wherein each bristle of the plurality of bristles is individually aligned generally radially with respect to the longitudinal axis.

21. The toothbrush of claim 12, wherein the bristle pad is removably attached to the distal end of the toothbrush.

22. A toothbrush comprising:
a proximal end and a distal end;
a longitudinal axis extending from the proximal end to the distal end; and
a bristle pad proximate the distal end of the toothbrush, the bristle pad comprising a plurality of bristles embedded in a base surface, wherein all of the bristles on the bristle pad are arranged in only a single group on the bristle pad, with the bristles in the single group dispersed uniformly within the single group, and wherein each bristle of the plurality of bristles is aligned generally radially with respect to the longitudinal axis, and wherein the base surface occupies an arc of 180 degrees or less with respect to the longitudinal axis.

23. The toothbrush of claim 22, wherein substantially all of the bristles on the bristle pad are individually oriented at an included angle of less than 90 degrees with the longitudinal axis as measured in a plane defined by the longitudinal axis and the bristle.

24. The toothbrush of claim 23, wherein substantially all of the bristles on the bristle pad are oriented in the same direction.

25. The toothbrush of claim 22, wherein the bristles in the single group are dispersed randomly within the single group.

26. The toothbrush of claim 22, wherein the base surface is in the form of an arcuate cylindrical segment.

27. The toothbrush of claim 22, wherein the plurality of bristles are arranged with a bristle density of 5 bristles/mm² or more proximate the base surface.

28. The toothbrush of claim 22, wherein the plurality of bristles are arranged with a bristle density of 25 bristles/mm² or less proximate the base surface.

29. The toothbrush of claim 22, wherein substantially all of the bristles of the plurality of bristles are individually in contact with at least one other bristle.

30. The toothbrush of claim 22, wherein the bristle pad is removably attached to the distal end of the toothbrush.

31. A motorized toothbrush comprising:
a proximal end and a distal end defining a longitudinal axis extending from the proximal end to the distal end;
a housing comprising a motor and a shaft; and
a bristle pad operably connected to the shaft for movement relative to the longitudinal axis;
wherein the bristle pad comprises a plurality of bristles embedded in a base surface, wherein the plurality of bristles are dispersed uniformly over the base surface, and wherein substantially all of the bristles of the plurality of bristles are individually in contact with at least one other bristle.

32. The motorized toothbrush of claim 31, wherein the plurality of bristles are arranged with a bristle density of 5 bristles/mm² or more proximate the base surface.

33. The motorized toothbrush of claim 31, wherein the plurality of bristles are arranged with a bristle density of 25 bristles/mm² or less proximate the base surface.

34. The motorized toothbrush of claim 31, wherein the plurality of bristles are dispersed randomly over the base surface.

35. The motorized toothbrush of claim 31, wherein the plurality of bristles are arranged in only a single group on the bristle pad, with the plurality of bristles dispersed uniformly within the single group.

36. The motorized toothbrush of claim 35, wherein the plurality of bristles are dispersed randomly within the single group.

37. The motorized toothbrush of claim 31, wherein substantially all of the bristles on the bristle pad are individually oriented at an included angle of less than 90 degrees with a plane defined by the base surface.

38. The motorized toothbrush of claim 37, wherein substantially all of the bristles on the bristle pad are oriented in the same direction.

39. The motorized toothbrush of claim 31, wherein the shaft is removably attached to the housing.

40. The motorized toothbrush of claim 31, wherein the bristle pad is removably attached to the shaft.
